(19) United States
(12) Patent Application Publication
(10) Pub. No.: US 2019/0232943 A1
(43) Pub. Date: Aug. 1, 2019

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventor: Takahito Fujita, Wako-shi (JP)

(21) Appl. No.: 16/245,295

(22) Filed: Jan. 11, 2019

(30) Foreign Application Priority Data
Feb. 1, 2018 (JP) 2018-016621

(51) Int. Cl. B60W 20/11; B60W 20/12

(52) U.S. Cl. CPC B60W 20/11; B60W 20/12

(57) ABSTRACT

A vehicle control system includes a power generator including an internal combustion engine and an electric motor, a storage battery that stores a generated power, a travel electric motor rotates a driving wheels using power supplied from the storage battery, a storage unit that stores a travel history of the vehicle, an extractor that checks information indicating a current position information and travel environment of the vehicle with the travel history to extract travel records having a degree of matching equal to or greater than a predetermined value, a future consumption estimator that estimates a future consumption of the vehicle on the basis of an energy consumption that is associated with a pattern of a travel record having a highest energy consumption of the vehicle or a travel record having a highest occurrence frequency, and a controller that activates the power generator on the basis of the estimated future consumption.

### CROSS-REFERENCE TO RELATED APPLICATION

Priority is claimed on Japanese Patent Application No. 2018-016621, filed Feb. 1, 2018, the content of which is incorporated herein by reference.

### BACKGROUND OF THE INVENTION

### Field of the Invention

The present invention relates to a vehicle control system, a vehicle control method, and a storage medium.

### Description of Related Art

In the related art, hybrid vehicles in which a storage battery and an internal combustion engine that outputs motive power for power generation are mounted have gained popularity. In relation to this, a technology in which a required amount of regeneration is calculated from an actual traveling state signal of a vehicle and a situation signal of the land where the vehicle is going to travel through a navigation device and a target amount of charge obtained by subtracting the required amount of regeneration from the capacity of the battery is compared with the current capacity of the battery to start a small engine for activating a power generator or to stop the operation of the small engine has been disclosed (see, for example, Japanese Unexamined Patent Application, First Publication No. 09-168206).

### SUMMARY OF THE INVENTION

However, according to the technology of the related art, when the vehicle is traveling while no destination has been set with the navigation device, the energy consumption for traveling cannot be calculated and a power generation plan cannot be generated in some cases.

Aspects of the present invention have been made in view of such circumstances and it is an object of the present invention to provide a vehicle control system, a vehicle control method, and a storage medium capable of generating an appropriate power generation plan in a wider range of situations.

The vehicle control system, the vehicle control method, and the storage medium according to the present invention adopt the following configurations.

(1) A vehicle control system according to an aspect of the present invention includes a power generator including an internal combustion engine configured to output motive power for use by an electric motor and the electric motor configured to generate power using the motive power output by the internal combustion engine, a storage battery configured to store power generated by the power generator, a travel electric motor connected to driving wheels of a vehicle and configured to be driven using power supplied from the storage battery to rotate the driving wheels, a storage unit configured to store a travel history in which an energy consumption of the vehicle and information indicating a travel environment of the vehicle are associated with a route from a departure point to a destination of the vehicle, an extractor configured to check information indicating a current position information and travel environment of the vehicle with the travel history stored in the storage unit to extract travel records having a degree of matching equal to or greater than a predetermined value, a future consumption estimator configured to estimate a future consumption of the vehicle on the basis of an energy consumption that is associated with a pattern of a travel record having a highest energy consumption of the vehicle or a travel record having a highest occurrence frequency among the travel records extracted by the extractor, and a controller configured to activate the power generator on the basis of the future consumption estimated by the future consumption estimator.

(2) In the above aspect (1), the future consumption estimator is configured to estimate the future consumption of the vehicle on the basis of an energy consumption that is associated with the pattern of the travel record having the highest occurrence frequency if occurrence frequencies of travel records are equal to or higher than a threshold value and to estimate the future consumption of the vehicle on the basis of an energy consumption that is associated with the travel record having the highest energy consumption of the vehicle if the occurrence frequencies are less than the threshold value.

(3) In the above aspect (1), the future consumption estimator is configured to estimate the future consumption of the vehicle on the basis of information indicating the current position information and travel environment of the vehicle at time intervals of a predetermined duration or each time the vehicle travels a predetermined distance.

(4) In the above aspect (1), the storage unit is configured to store charging point information regarding points where charging of the vehicle is possible, and the future consumption estimator is configured to estimate the future consumption of the vehicle on the basis of an energy consumption of a travel record acquired by giving higher priority to a travel record having no point where charging of the vehicle is possible than a travel record having a point where charging of the vehicle is possible among the travel records extracted by the extractor on the basis of the charging point information stored in the storage unit.

(5) A vehicle control method according to an aspect of the present invention is a vehicle control method for a computer mounted in a vehicle including a power generator having an internal combustion engine configured to output motive power for use by an electric motor and the electric motor configured to generate power using the motive power output by the internal combustion engine, a storage battery configured to store power generated by the power generator, and a travel electric motor connected to driving wheels of the vehicle and configured to be driven using power supplied from the storage battery to rotate the driving wheels, wherein the computer stores a travel history in which an energy consumption of the vehicle and information indicating a travel environment of the vehicle are associated with a route from a departure point to a destination of the vehicle in a storage unit, checks information indicating a current position information and travel environment of the vehicle with the travel history stored in the storage unit to extract travel records having a degree of matching equal to or greater than a predetermined value, estimates a future consumption of the vehicle on the basis of an energy consumption that is associated with a pattern of a travel record having a highest energy consumption of the vehicle or a travel record having a highest occurrence frequency among the extracted travel records, and activates the power generator on the basis of the estimated future consumption.

(6) A computer readable non-transitory storage medium according to an aspect of the present invention stores a program for a computer mounted in a vehicle including a power generator having an internal combustion engine configured to output motive power for use by an electric motor and the electric motor configured to generate power using the motive power output by the internal combustion engine, a storage battery configured to store power generated by the power generator, and a travel electric motor connected to driving wheels of the vehicle and configured to be driven using power supplied from the storage battery to rotate the driving wheels, wherein the program causes the computer to store a travel history in which an energy consumption of the vehicle and information indicating a travel environment of the vehicle are associated with a route from a departure point to a destination of the vehicle in a storage unit, to check information indicating a current position information and travel environment of the vehicle with the travel history stored in the storage unit to extract travel records having a degree of matching equal to or greater than a predetermined value, to estimate a future consumption of the vehicle on the basis of an energy consumption that is associated with a pattern of a travel record having a highest energy consumption of the vehicle or a travel record having a highest occurrence frequency among the extracted travel records, and to generate a power generation plan for activating the power generator on the basis of the estimated future consumption.

According to the above aspects (1) to (6), it is possible to generate an appropriate power generation plan in a wider range of situations.

### BRIEF DESCRIPTION OF THE DRAWINGS

FIG. 1 is a diagram showing an example of the configuration of a vehicle in which a vehicle system is mounted.

FIG. 2 is a diagram showing an example of the functional configuration of a plan controller.

FIG. 3 is a diagram showing an example of the content of a travel record.

FIG. 4 is a diagram showing an example of the content of charging point information.

FIG. 5 is a diagram showing estimation of a future consumption through a first method of a future consumption estimator.

FIG. 6 is a diagram showing estimation of a future consumption through a second method of the future consumption estimator.

FIG. 7 is a diagram showing estimation of a future consumption through a fourth method of the future consumption estimator.

FIG. 8 is a flowchart showing the flow of a process performed by the vehicle system.

FIG. 9 is a flowchart showing an example of the flow of a process performed through the fourth method of the future consumption estimator.

FIG. 10 is a diagram showing an example of the hardware configuration of the plan controller according to an embodiment.

### DETAILED DESCRIPTION OF THE INVENTION

Embodiments of a vehicle control system, a vehicle control method, and a storage medium according to the present invention will be described below with reference to the drawings.

### [Overall Configuration]

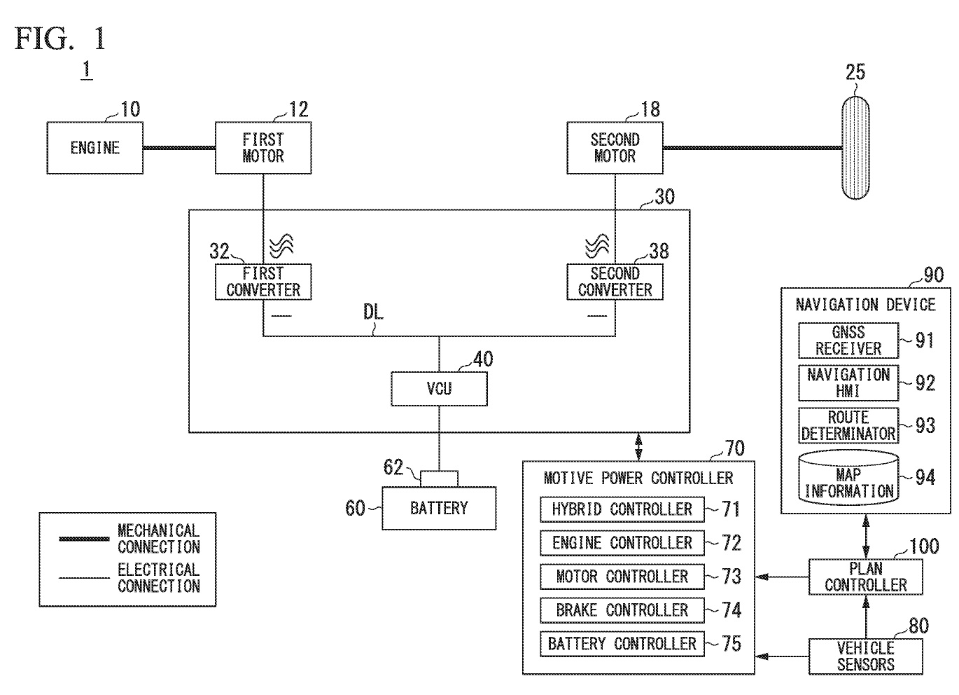

FIG. 1 is a diagram showing an example of the configuration of a vehicle in which a vehicle system 1 is mounted. A vehicle in which the vehicle system (an example of the vehicle control system) 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. When an electric motor is provided, the electric motor operates using electric power generated by an electric motor connected to the internal combustion engine or using discharge power of a secondary battery or a fuel cell. In the following description, a hybrid vehicle adopting a series system will be described as an example. The series system is a system in which an engine and driving wheels are not mechanically connected, the motive power of the engine is used for power generation by an electric motor, and the generated electric power is supplied to a travel electric motor. This vehicle may be a vehicle capable of plug-in charging a battery.

As shown in FIG. 1, for example, an engine 10, a first motor (electric motor) 12, a second motor (electric motor) 18, driving wheels 25, a power control unit (PCU) 30, a battery (storage battery) 60, a motive power controller (an example of the controller) 70, vehicle sensors 80, a navigation device 90, and a plan controller 100 are mounted on the vehicle (hereinafter referred to as a vehicle M).

The engine 10 is an internal combustion engine that outputs motive power by burning fuel such as gasoline. The engine 10 is, for example, a reciprocating engine including a cylinder and a piston, an intake valve, an exhaust valve, a fuel injection device, a spark plug, a connecting rod, a crankshaft, and the like. The engine 10 is, for example, a four-cycle engine, although other cycle types may also be used. Anything that generates motive power such as a diesel engine, a gas turbine engine, a rotary engine, or an external combustion engine may be used as the engine 10. The motive power that can be output by the engine 10 is less than the motive power necessary for the first motor 12 to generate the amount of electric energy for driving the second motor 18 in real time (or the amount of electric energy capable of running the vehicle M at a predetermined speed or more). Since the engine 10 is small and lightweight, the engine 10 has an advantage that the degree of vehicle layout freedom is high.

The first motor 12 is, for example, a three-phase AC electric motor. The first motor 12 has a rotor connected to an output shaft (for example, a crankshaft) of the engine 10 and generates power using the motive power output by the engine 10.

The second motor 18 is, for example, a travel electric motor that rotates the driving wheels 25. The second motor 18 is a three-phase AC electric motor. The second motor 18 performs driving and regeneration of the vehicle. A rotor of the second motor 18 is connected to the driving wheels 25. The second motor 18 outputs motive power to the driving wheels 25 using received electric power. The second motor 18 generates electric power using kinetic energy of the vehicle when the vehicle decelerates. Hereinafter, this power generation operation of the second motor 18 will sometimes be referred to as regeneration.

The PCU 30 includes, for example, a first converter 32, a second converter 38, and a voltage control unit (VCU) 40. Formation of these constituent elements into the PCU 30 as a single unit is merely an example, and these constituent elements may be arranged in a distributed fashion.

The first converter 32 and the second converter 38 are, for example, AC-DC converters. DC-side terminals of the first converter 32 and the second converter 38 are connected to a DC link DL. A battery 60 is connected to the DC link DL via the VCU 40. The first converter 32 converts an alternating current generated by the first motor 12 into a direct current and outputs the direct current to the DC link DL or converts a direct current received via the DC link DL into an alternating current and supplies the alternating current to the first motor 12. Similarly, the second converter 38 converts an alternating current generated by the second motor 18 into a direct current and outputs the direct current to the DC link DL or converts a direct current received via the DC link DL into an alternating current and supplies the alternating current to the second motor 18.

The VCU 40 is, for example, a DC-DC converter. The VCU 40 boosts power received from the battery 60 and outputs it to the DC link DL.

The battery 60 is, for example, a secondary battery such as a lithium ion battery. The battery 60 stores, for example, power generated by the power generator (the engine 10 and the first motor 12). The battery 60 may store regenerative power obtained by the second motor 18.

The motive power controller 70 includes, for example, a hybrid controller 71, an engine controller 72, a motor controller 73, a brake controller 74, and a battery controller 75. The hybrid controller 71 outputs instructions to the engine controller 72, the motor controller 73, the brake controller 74, and the battery controller 75. Instructions of the hybrid controller 71 will be described later.

In accordance with an instruction from the hybrid controller 71, the engine controller 72 performs ignition control, throttle opening degree control, fuel injection control, fuel cut control, or the like of the engine 10. The engine controller 72 may calculate the rotation rate of the engine on the basis of the output of a crank angle sensor attached to the crankshaft and output the engine rotation rate to the hybrid controller 71.

In accordance with an instruction from the hybrid controller 71, the motor controller 73 performs switching control of the first converter 32 and/or the second converter 38.

In accordance with an instruction from the hybrid controller 71, the brake controller 74 controls a brake device (not shown). The brake device is a device that outputs a brake torque corresponding to a braking operation of a driver to each wheel.

The battery controller 75 calculates the amount of electric energy (for example, the state of charge) of the battery 60 on the basis of the output of a battery sensor 62 attached to the battery 60 and outputs it to the hybrid controller 71.

The vehicle sensors 80 include, for example, an accelerator opening degree sensor, a vehicle speed sensor, and a brake pedal depression amount sensor. The accelerator opening degree sensor is attached to an accelerator pedal which is an example of an operator which receives an acceleration instruction from the driver and detects and outputs the amount of operation of the accelerator pedal to the power controller 70 as an accelerator opening degree. The vehicle speed sensor includes, for example, wheel speed sensors attached to the wheels and a speed calculator and combines wheel speeds detected by the wheel speed sensors to derive the speed of the vehicle (vehicle speed) and outputs the derived speed to the motive power controller 70. The brake pedal depression amount sensor is attached to a brake pedal which is an example of an operator that receives a deceleration or stop instruction from the driver and detects and outputs the amount of operation of the brake pedal to the power controller 70 as a brake pedal depression amount.

The vehicle sensors 80 may include a temperature sensor that detects a temperature outside the vehicle M. The vehicle sensors 80 may include a weather sensor that acquires the weather outside the vehicle or the like.

The navigation device 90 includes, for example, a global navigation satellite system (GNSS) receiver 91, a navigation HMI 92, and a route determinator 93 and holds map information 94 in a storage device such as a hard disk drive (HDD) or a flash memory. The GNSS receiver 91 specifies the position of the vehicle M on the basis of signals received from GNSS satellites. The position of the vehicle M may also be specified or supplemented by an inertial navigation system (INS) using the output of the vehicle sensors 80. The navigation HMI 92 includes a display device, a speaker, a touch panel, a key, or the like. For example, the route determinator 93 determines a route from the position of the vehicle M specified by the GNSS receiver 91 (or an arbitrary input position) to a destination input by the occupant (hereinafter referred to as an on-map route) using the navigation HMI 92 by referring to the map information 94. The route determinator 93 may generate a travel plan including the scheduled times or the like of travel on roads included in the route. The travel plan is a plan incorporating the time when the user desires to arrive at the destination, congestion information on the road, the route through which the user desires to pass, the type of the road through which the user desires to pass, and the like. The travel plan is displayed, for example, on the navigation HMI 92. The occupant controls the vehicle according to the travel plan displayed on the navigation HMI 92. The vehicle M of the present embodiment may be an automated driving vehicle that automatically controls the steering and acceleration/deceleration of the vehicle on the basis of the travel plan and surrounding situations of the vehicle M. The on-map route and the travel plan determined by the route determinator 93 are output to the plan controller 100. The map information 94 is, for example, information representing shapes of roads by links indicating roads and nodes connected by the links. The map information 94 may include curvatures of roads, point of interest (POI) information, or the like. The map information 94 may also include information on chargeable points.

Here, control performed by the hybrid controller 71 will be described. First, the hybrid controller 71 derives a drive shaft torque demand Td on the basis of the accelerator opening degree and a target vehicle speed and determines a drive shaft power demand Pd which is to be output from the second motor 18. The hybrid controller 71 determines whether or not to activate the engine 10 on the basis of the determined drive shaft power demand Pd, the power consumption of auxiliary devices, the amount of electric energy of the battery 60, or the like, and determines an engine power Pe to be output by the engine 10 upon determining that the engine 10 is to be activated.

In accordance with the determined engine power Pe, the hybrid controller 71 determines the reaction torque of the first motor 12 such that it is balanced with the engine power Pe. The hybrid controller 71 outputs the determined information to the engine controller 72. When the brake is operated by the driver, the hybrid controller 71 determines a distribution of a brake torque that can be output by regeneration of the second motor 18 and a brake torque that is to be output by the brake device and outputs the determined result to the motor controller 73 and the brake controller 74.

### [Functional Configuration of Plan Controller]

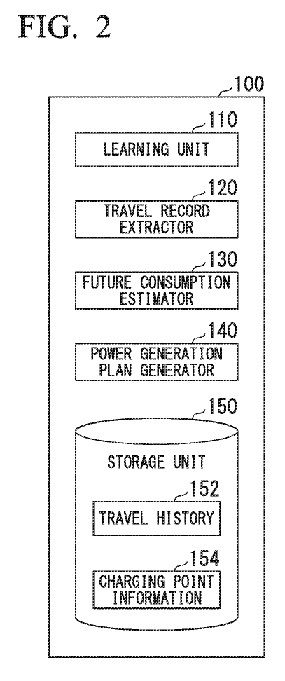

FIG. 2 is a diagram showing an example of the functional configuration of the plan controller 100. The plan controller 100 includes, for example, a learning unit 110, a travel record extractor (an example of the extractor) 120, a future consumption estimator 130, a power generation plan generator 140, and a storage unit 150. The learning unit 110, the travel record extractor 120, the future consumption estimator 130, and the power generation plan generator 140 are realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by hardware and software in cooperation.

The learning unit 110 learns an energy consumption from the departure point of the vehicle M to the arrival point. For example, the learning unit 110 sets position information at a point in time when the vehicle M is controlled to an ON state by an operation of the occupant (for example, when the vehicle M is controlled to a state where the vehicle M can start as the accelerator pedal is operated) as the departure point and sets position information at a point in time when the vehicle M is controlled to an OFF state by an operation of the occupant as the arrival point. The position information is, for example, a latitude and longitude (X, Y). The learning unit 110 may acquire position information of at least one intermediate point (for example, points at intervals of 5 [km]) from the departure point to the arrival point. The learning unit 110 may also acquire the position information of the destination and the position information of intermediate points (waypoints) from the departure point to the destination point from the navigation device 90.

The learning unit 110 derives the energy consumption from the departure point to the arrival point (including from the departure point to an intermediate point, between intermediate points, and from an intermediate point to the arrival point). In this case, for example, the learning unit 110 calculates the difference between the amount of electric energy (state of charge) of the battery 60 at the departure time and the amount of electric energy of the battery 60 at the arrival time and the cumulative energy consumption of the second motor 18 and in-vehicle devices, and derives the energy consumption of the vehicle M during travel on the basis of the calculated result. That is, the learning unit 110 derives an actual energy consumption not merely considering the distance but also considering time such as that of congestion, road gradients, and the like.

The learning unit 110 acquires information indicating the travel environment of the vehicle. The information indicating the travel environment is, for example, the temperature, the weather, and date and time information. For example, the learning unit 110 acquires the temperature and weather outside the vehicle from the vehicle sensors 80. The learning unit 110 may communicate with an external device via a communication device (not shown) mounted on the vehicle M to acquire temperature information and weather information regarding the traveling position of the vehicle M. The learning unit 110 acquires date and time information from a timer unit mounted on the vehicle M.

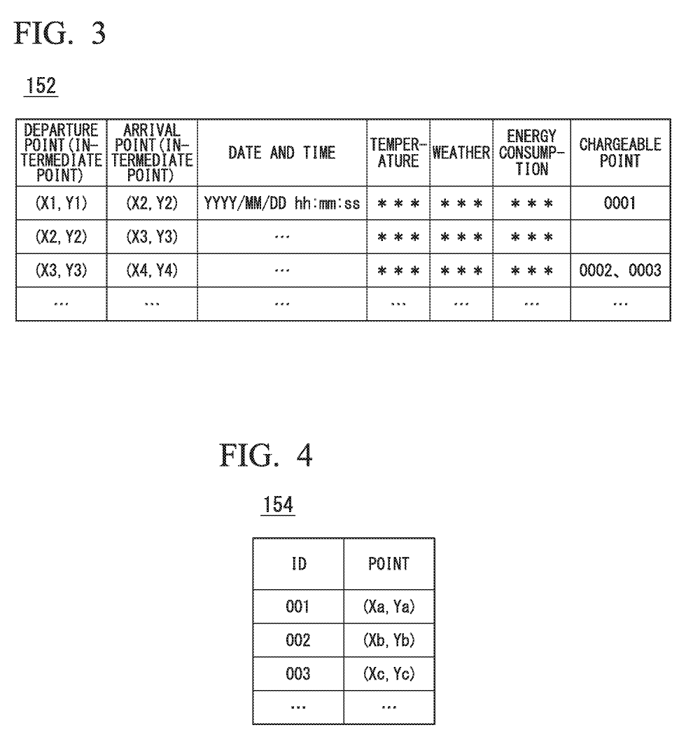

Then, for example, the learning unit 110 stores information in which the derived energy consumption and the information indicating the travel environment are associated with information on the position information of the departure point and the position information of the arrival point in the storage unit 150 as a travel history 152. FIG. 3 is a diagram showing an example of the content of the travel history 152. In the travel history 152, information in which information indicating the travel environment (date and time, temperature, and weather), an energy consumption, and a chargeable point are associated with a departure point and an arrival point are stored as one record. Information stored as the departure and arrival points in the travel history 152 in FIG. 3 may include information on intermediate points. For example, FIG. 3 shows an example in which (X2, Y2) and (X3, Y3) are extracted as intermediate points in a route from a departure point (X1, Y1) to an arrival point (X4, Y4). By storing such information including information on intermediate points in the travel history 152 in this way, it is possible to manage the travel environment and the energy consumption in smaller sections.

The chargeable point is information on a chargeable point(s) passed by between the departure point and the arrival point. In the example of FIG. 3, IDs of charging point information 154 stored in advance in the storage unit 150 are stored as the chargeable point. FIG. 4 is a diagram showing an example of the content of the charging point information 154. The charging point information 154 is information in which points (position information) are associated with IDs that are identification information of chargeable points. The charging point information 154 may be acquired from the map information 94 or the learning unit 110 may register points where the vehicle M was charged in the past as charging point information 154. The chargeable point may be a departure point or an arrival point.

The learning unit 110 may delete data, after whose storage a predetermined period has elapsed, among data stored in the travel history 152 and the charging point information 154. Thereby, old data can be deleted to adjust the amount of data and the travel record extractor 120 can also extract the travel record using the latest data.

The travel record extractor 120 acquires the position information of the vehicle M, for example, when the vehicle M is controlled to an on state by an operation of the occupant. The travel record extractor 120 acquires information indicating the travel environment of the vehicle M at that time. Then, the travel record extractor 120 performs checking with the travel history 152 on the basis of the acquired position information and travel environment. In this case, the position information of the vehicle M is checked with the departure point of the travel history 152, and the travel environment of the vehicle M is checked with the travel environment of the travel history 152. The travel record extractor 120 then extracts destinations of travel records in which the degree of matching between the acquired position information and travel environment and the position information and travel environment of the travel history 152 is equal to or greater than a predetermined value as candidate destinations.

For example, the travel record extractor 120 first checks the current position of the vehicle M with data of the departure point of the travel history 152 and extracts travel records including departure points within a predetermined range from the current position. Next, the travel record extractor 120 extracts patterns of travel records in which the degree of matching of the information indicating the travel environment is equal to or greater than a predetermined value from the extracted records. For example, the degree of matching increases as the difference between the position information of the vehicle M and the departure point of the travel history 152 decreases, as the current date and time of the vehicle M is closer to the date and time information of the travel history 152, or as the current temperature of the vehicle M is closer to the temperature of the travel history 152. When the current weather is sunny, “sunny” in the travel history 152 has the highest degree of matching with the current weather, and then “cloudy,” “rain,” and “snow” are in descending order of the degree of matching.

The future consumption estimator 130 estimates the amount of energy that the vehicle M will consume in the future (hereinafter referred to as a future consumption) using a predetermined method. The future consumption estimator 130 may estimate a future consumption each time a predetermined duration elapses from first estimation of the future consumption or each time the vehicle M travels a predetermined distance. Details of the function of the future consumption estimator 130 will be described later.

The power generation plan generator 140 generates a power generation plan for activating the power generator on the basis of the future consumption estimated by the future consumption estimator 130. The power generation plan is, for example, a plan for charging the battery 60 or a plan for activating the second motor 18 to run the vehicle M by the driving wheels 25. The motive power controller 70 controls the activation of the power generator on the basis of the power generation plan generated by the power generation plan generator 140.

When a destination has been set by the navigation device 90, the power generation plan generator 140 may generate the power generation plan on the basis of a behavior plan to the destination.

The storage unit 150 is realized, for example, by a nonvolatile storage device such as a read only memory (ROM), an electrically erasable and programmable read only memory (EEPROM), or a hard disk drive (HDD), or a volatile storage device such as a random access memory (RAM) or a register. The storage unit 150 stores, for example, the travel history 152, the charging point information 154, and other information.

### [Functions of Future Consumption Estimator]

The future consumption estimator 130 estimates the future consumption of the vehicle M, for example, using the following four methods (1) to (4).

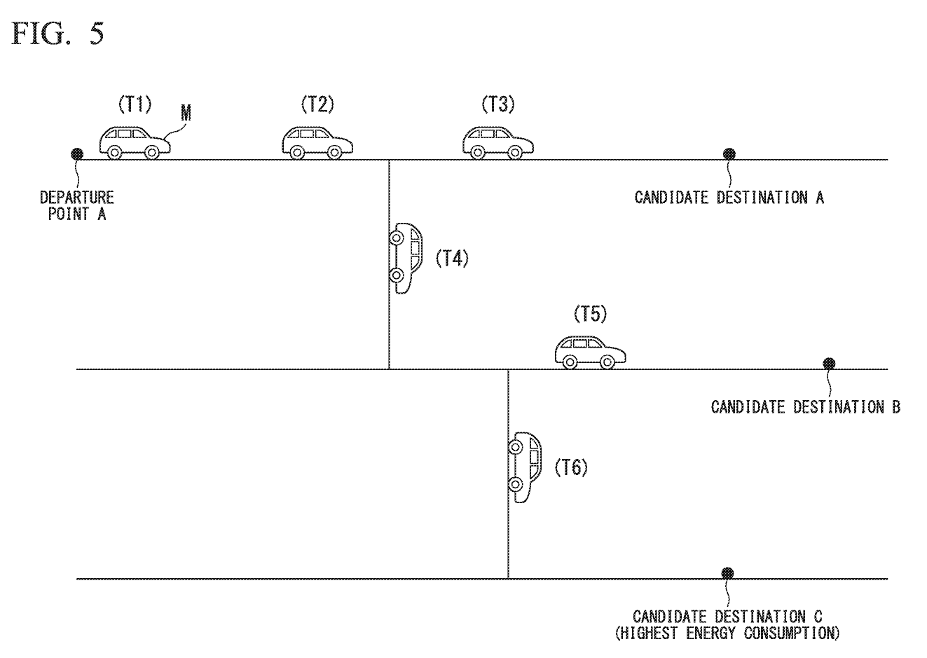

(1) The future consumption estimator 130 estimates the future consumption of the vehicle M on the basis of an energy consumption that is associated with the pattern of a travel record having the highest energy consumption of the vehicle M among the patterns of the travel records extracted by the travel record extractor 120. FIG. 5 is a diagram showing estimation of the future consumption through a first method of the future consumption estimator 130. In FIG. 5, it is assumed that the future consumption estimator 130 estimates the future consumption at each of times (T1) to (T6).

For example, at time (T1) when the vehicle M is controlled to the ON state at departure point A, the travel record extractor 120 checks information indicating the current position and travel environment of the vehicle with the travel history 152 and extracts travel records in which the degree of matching with the information indicating the current position and travel environment is equal to or greater than a predetermined value, and extracts arrival points of the extracted travel records as candidate destinations. In the example of FIG. 5, three candidate destinations A to C are extracted. The future consumption estimator 130 estimates the future consumption of the vehicle M on the basis of an energy consumption that is associated with the travel record of the candidate destination C which consumes the highest amount of energy among those corresponding to the three candidate destinations A to C. For example, the future consumption estimator 130 may estimate the energy consumption of the candidate destination C as a future consumption or estimate a value obtained by adding a predetermined energy consumption to the energy consumption of the candidate destination C as the future consumption.

At time (T2) shown in FIG. 5, it is unknown where the vehicle M is going among the candidate destinations A to C. Therefore, the future consumption estimator 130 estimates the future consumption on the basis of an energy consumption that is associated with the travel record from the current position to the candidate destination C which has the highest energy consumption. At time (T3) shown in FIG. 5, the vehicle M is out of the routes toward the candidate destinations B and C in the travel history and is traveling along a route toward the candidate destination A, and therefore the vehicle M is likely to be going to the candidate destination A. Thus, the future consumption estimator 130 estimates the future consumption on the basis of an energy consumption that is associated with the travel record from the current position to the candidate destination A.

At time (T4) shown in FIG. 5, the vehicle is traveling along a route toward the candidate destinations B and C in the travel history, and therefore it is unknown whether the vehicle M is going to the candidate destination B or the candidate destination C. Thus, the future consumption estimator 130 estimates the future consumption on the basis of an energy consumption that is associated with the travel record to the candidate destination C having the highest energy consumption. At time (T5) shown in FIG. 5, the vehicle M is out of the routes toward the candidate destinations A and C in the travel history and is traveling along a route toward the candidate destination B, and therefore the vehicle M is likely to be going to the candidate destination B. Thus, the future consumption estimator 130 estimates the future consumption on the basis of an energy consumption that is associated with the travel record from the current position to the candidate destination B. At time (T6) shown in FIG. 5, the vehicle M is out of the routes toward the candidate destinations A and B in the travel history and is traveling along a route toward the candidate destination C, and therefore the vehicle M is likely to be going to the candidate destination C. Thus, the future consumption estimator 130 estimates the future consumption on the basis of an energy consumption that is associated with the travel record from the current position to the candidate destination C.

As a result, it is possible to estimate the future consumption to be on the safe side such that the energy consumption will not be insufficient.

(2) The future consumption estimator 130 estimates the future consumption of the vehicle M on the basis of an energy consumption that is associated with the pattern of a travel record having the highest occurrence frequency among the patterns of the travel records extracted by the travel record extractor 120. The pattern of a travel record is, for example, a pattern of pairs of a departure point and an arrival point which may include information on an intermediate point.

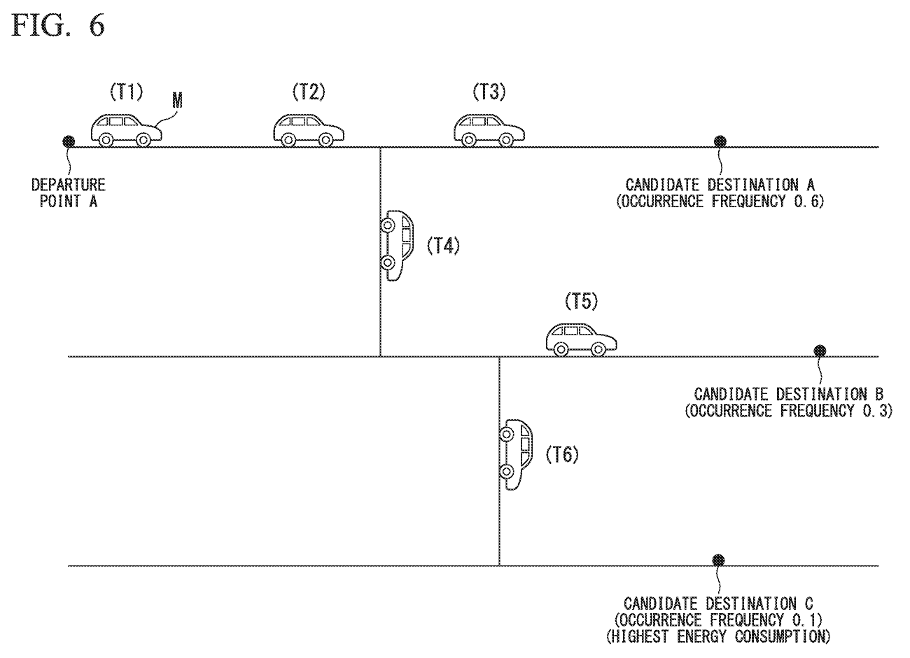

FIG. 6 is a diagram showing estimation of the future consumption through a second method of the future consumption estimator 130. In the example of FIG. 6, the respective occurrence frequencies of candidate destinations A to C have been set. In FIG. 6, it is assumed that the occurrence frequency of the candidate destination A is 0.6, the occurrence frequency of the candidate destination B is 0.3, and the occurrence frequency of the candidate destination C is 0.1. In this case, when estimating the future consumption at times (T1) and (T2) shown in FIG. 6, the future consumption estimator 130 estimates the future consumption on the basis of an energy consumption that is associated with the travel record from the current position to the candidate destination A whose occurrence frequency is equal to or higher than a predetermined value (for example, 0.5).

At time (T3) shown in FIG. 6, the vehicle M is likely to be going to the candidate destination A and therefore the future consumption estimator 130 estimates the future consumption on the basis of the energy consumption from the current position to the candidate destination A. At time (T4) shown in FIG. 6, it is unknown whether the vehicle M is going to the candidate destination B or the candidate destination C, the future consumption estimator 130 estimates the future consumption on the basis of an energy consumption that is associated with the travel record from the current position to the candidate destination B having a higher occurrence frequency. At time (T5) shown in FIG. 6, the future consumption estimator 130 estimates the future consumption on the basis of the energy consumption from the current position to the candidate destination B. At time (T6) shown in FIG. 6, the future consumption estimator 130 estimates the future consumption on the basis of the energy consumption from the current position to the candidate destination C. In the second method, the future consumption estimator 130 may estimate the future consumption using the number of occurrences instead of the occurrence frequency.

As a result, it is possible to estimate a future consumption closer to the reality than the above method (1).

(3) For example, when the occurrence frequencies of one or more travel records are equal to or higher than a threshold value, the future consumption estimator 130 estimates the future consumption of the vehicle M on the basis of an energy consumption that is associated with the pattern of a travel record having the highest occurrence frequency, and, when the occurrence frequencies of the travel records are less than the threshold value (when there is no travel record having an occurrence frequency equal to or higher than the threshold value), the future consumption estimator 130 estimates the future consumption of the vehicle M on the basis of an energy consumption that is associated with a travel record having the highest energy consumption of the vehicle M. As a result, the future consumption can be estimated to be on the safe side if the travel route lacks a certain degree of reliability and a future consumption closer to the reality can be estimated if it is reliable.

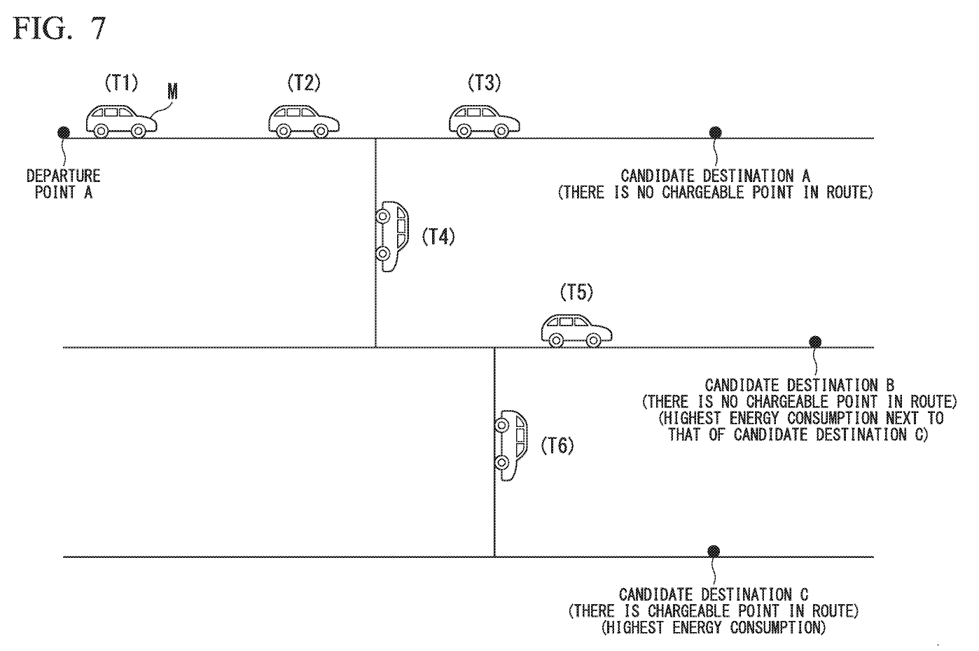

(4) The future consumption estimator 130 gives a higher priority level when there is no chargeable point in the route from the current position to the candidate destination than when there is a chargeable point in the route from the current position to the candidate destination. FIG. 7 is a diagram showing estimation of the future consumption through a fourth method of the future consumption estimator 130. In the example of FIG. 7, information as to whether or not there is a chargeable point in each of the routes to the candidate destinations A to C has been set. In FIG. 7, it is assumed that there is no chargeable point on the routes from the departure point to the candidate destinations A and B and there is a chargeable point on the route from the departure point to the chargeable point C.

When estimating the future consumption at times (T1) and (T2) shown in FIG. 7, the future consumption estimator 130 first selects the candidate destination C having the highest energy consumption. However, since there is a chargeable point in the route to the candidate destination C, the future consumption estimator 130 selects the candidate destination B having the next highest energy consumption. Here, since there is no chargeable point in the route to the candidate destination B, the future consumption estimator 130 gives priority to the candidate destination B having no chargeable point and estimates the future consumption on the basis of an energy consumption that is associated with the travel record of the candidate destination B.

At time (T3) shown in FIG. 7, the vehicle M is likely to be going to the candidate destination A and therefore the future consumption estimator 130 estimates the future consumption on the basis of an energy consumption that is associated with the travel record from the current position to the candidate destination A. At time (T4) shown in FIG. 7, it is unknown whether the vehicle M is going to the candidate destination B or the candidate destination C and therefore the future consumption estimator 130 estimates the future consumption on the basis of an energy consumption that is associated with the travel record of the candidate destination B which has no chargeable point in the route among the two candidates. At time (T5) shown in FIG. 7, the future consumption estimator 130 estimates the future consumption on the basis of the energy consumption from the current position to the candidate destination B. At time (T6) shown in FIG. 7, the future consumption estimator 130 estimates the future consumption on the basis of an energy consumption based on the travel record from the current position to the candidate destination C.

As a result, on the basis of the presence or absence of a chargeable point in the route, it is possible to estimate the future consumption to be more on the safe side such that the energy consumption will not be insufficient while charging is not possible.

### [Process Flow]

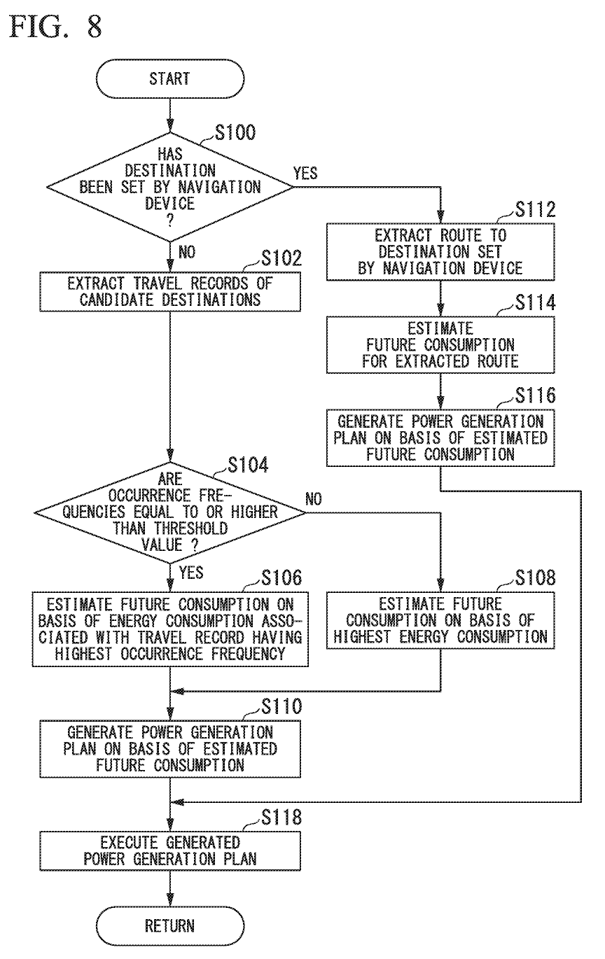

FIG. 8 is a flowchart showing a flow of a process performed by the vehicle system 1. In the process of FIG. 8, it is assumed that learning of the travel history 152 is performed by the learning unit 110. The process flow of FIG. 8 mainly illustrates the process through the third method of the future consumption estimator 130 described above. First, the plan controller 100 determines whether or not a destination has been set by the navigation device 90 (step S100). If it is determined that no destination has been set by the navigation device 90, the travel record extractor 120 refers to the travel history 152 stored in the storage unit 150 and extracts travel records of candidate destinations (step S102).

Next, the future consumption estimator 130 determines whether or not the occurrence frequencies of the extracted travel records are equal to or higher than a threshold value (step S104). Upon determining that the occurrence frequencies of some travel records are equal to or higher than the threshold value, the future consumption estimator 130 estimates the future consumption on the basis of an energy consumption that is associated with a travel record having the highest occurrence frequency (step S106). Upon determining that the occurrence frequencies of the travel records are not equal to or higher than the threshold value, the future consumption estimator 130 estimates the future consumption on the basis of the highest energy consumption (step S108). Next, the power generation plan generator 140 generates a power generation plan on the basis of the estimated future consumption (step S110).

If it is determined in step S100 that a destination has been set by the navigation device 90, the power generation plan generator 140 extracts a route to the destination set by the navigation device 90 (step S112) and estimates the future consumption for the extracted route (step S114). Next, the power generation plan generator 140 generates a power generation plan on the basis of the estimated future consumption (step S116). After completion of the processing of steps S110 and S116, the generated power generation plan is executed (step S118). Then, the process of this flowchart ends. The process shown in FIG. 8 may be repeatedly executed at predetermined times or at a predetermined cycle.

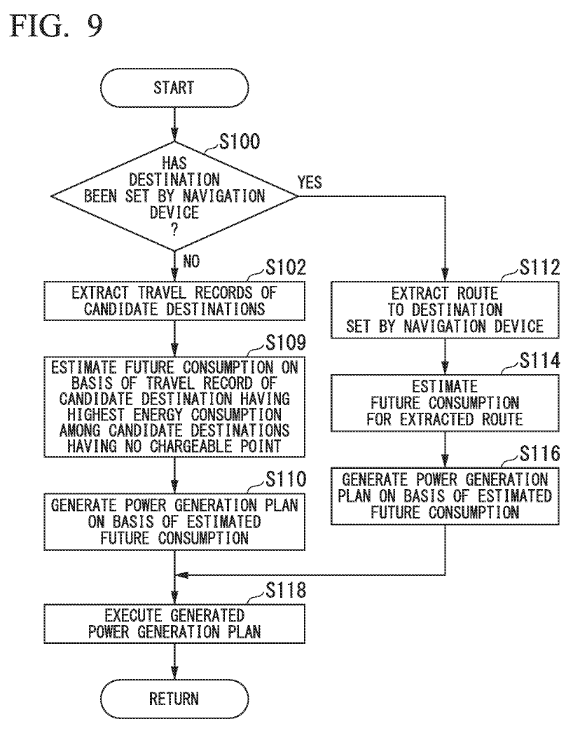

FIG. 9 is a flowchart showing an example of the flow of a process performed through the fourth method of the future consumption estimator 130. In the process of FIG. 9, a description of processing similar to the flowchart shown in FIG. 8 will be omitted. In comparison with the flowchart shown in FIG. 8, the flowchart shown in FIG. 9 has a process of S109 in place of the processes of steps S104 to S108. In the process of step S109, the future consumption is estimated on the basis of a travel record of a candidate destination having the highest energy consumption among candidate destinations having no chargeable point (step S109).

According to the embodiment described above, the power generator including the engine 10 configured to output motive power and the first motor 12 configured to generate power using the motive power output by the engine 10, the storage unit 150 configured to store a travel history in which an energy consumption of the vehicle M and information indicating a travel environment of the vehicle M are associated with a route from a departure point to a destination of the vehicle M, the travel record extractor 120 configured to perform checking with the travel history stored in the storage unit 150 on the basis of information indicating a current position information and travel environment of the vehicle M to extract travel records having a degree of matching equal to or greater than a predetermined value, the future consumption estimator 130 configured to estimate the future consumption of the vehicle M on the basis of an energy consumption that is associated with a pattern of a travel record having the highest energy consumption of the vehicle M or a travel record having the highest occurrence frequency among the travel records extracted by the travel record extractor 120, and the power generation plan generator 140 configured to generate a power generation plan for activating the power generator on the basis of the future consumption estimated by the future consumption estimator 130 are provided, whereby it is possible to provide an appropriate power generation plan in a wider range of situations.

According to the present embodiment, even in a situation where no destination has been set by the navigation device 90 such that the destination and the route of the vehicle M are not narrowed down, it is possible to estimate the consumption for traveling and to optimize management control of the amount of electric energy to be generated. According to the present embodiment, even when no destination has been set by the navigation device 90 or the like, it is possible to generate a power generation plan by performing route estimation and therefore it is possible to reduce the occupant's anxiety about power deficiency or the like.

According to the present embodiment, it is possible to reconsider a power generation plan according to the travel environment of the vehicle M or the like by estimating the future consumption of the vehicle at time intervals of a predetermined duration or each time the vehicle M travels a predetermined distance, and thus it is possible to generate a more appropriate power generation plan.

### [Hardware Configuration]

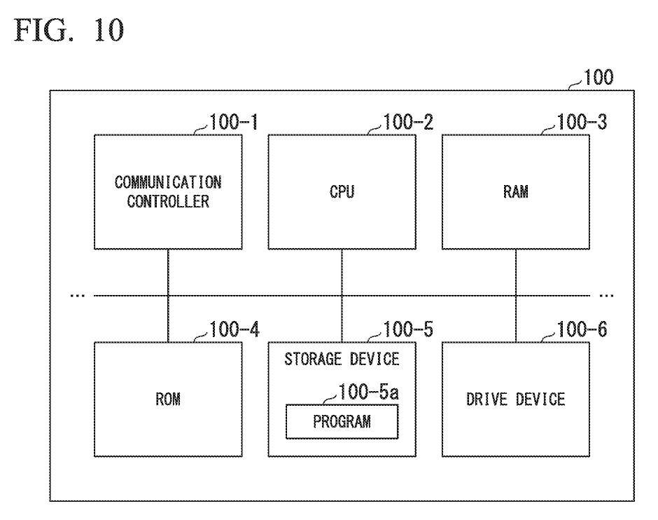

The plan controller 100 of the vehicle system 1 of the embodiment described above is realized, for example, by a hardware configuration as shown in FIG. 10. FIG. 10 is a diagram showing an example of the hardware configuration of the plan controller 100 of the embodiment.

The plan controller 100 is configured such that a communication controller 100-1, a CPU 100-2, a RAM 100-3, a ROM 100-4, a storage device 100-5 such as a flash memory or an HDD, and a drive device 100-6 are connected to each other via an internal bus or a dedicated communication line. A portable storage medium such as an optical disc (for example, a computer readable non-transitory storage medium) is mounted in the drive device 100-6. A program 100-5a stored in the storage device 100-5 is loaded in the RAM 100-3 by a DMA controller (not shown) or the like and then executed by the CPU 100-2, thereby realizing the functional units of the plan controller 100. The program referred to by the CPU 100-2 may be stored in the portable storage medium mounted in the drive device 100-6 or may be downloaded from another device via a network NW.

The embodiments described above can be expressed as follows.

A vehicle control system includes a storage device and a hardware processor configured to execute a program stored in the storage device, wherein the hardware processor executes the program to:

store, for a vehicle including a power generator having an internal combustion engine configured to output motive power for use by an electric motor and the electric motor configured to generate power using the motive power output by the internal combustion engine, a storage battery configured to store power generated by the power generator, and a travel electric motor connected to driving wheels of the vehicle and configured to be driven using power supplied from the storage battery to rotate the driving wheels, a travel history in which an energy consumption of the vehicle and information indicating a travel environment of the vehicle are associated with a route from a departure point to a destination of the vehicle in a storage unit;

check information indicating a current position information and travel environment of the vehicle with the travel history stored in the storage unit to extract travel records having a degree of matching equal to or greater than a predetermined value;

estimate a future consumption of the vehicle on the basis of an energy consumption that is associated with a pattern of a travel record having a highest energy consumption of the vehicle or a travel record having a highest occurrence frequency among the extracted travel records; and

activate the power generator on the basis of the estimated future consumption.

Although the mode for carrying out the present invention has been described above by way of embodiments, the present invention is not limited to such embodiments at all and various modifications and substitutions can be made without deviating from the spirit of the present invention.

What is claimed is:

1. A vehicle control system comprising:
a power generator including an internal combustion engine configured to output motive power for use by an electric motor and the electric motor configured to generate power using the motive power output by the internal combustion engine;
a storage battery configured to store power generated by the power generator;
a travel electric motor connected to driving wheels of a vehicle and configured to be driven using power supplied from the storage battery to rotate the driving wheels;
a storage unit configured to store a travel history in which an energy consumption of the vehicle and information indicating a travel environment of the vehicle are associated with a route from a departure point to a destination of the vehicle;
an extractor configured to check information indicating a current position information and travel environment of the vehicle with the travel history stored in the storage unit to extract travel records having a degree of matching equal to or greater than a predetermined value;
a future consumption estimator configured to estimate a future consumption of the vehicle on the basis of an energy consumption that is associated with a pattern of a travel record having a highest energy consumption of the vehicle or a travel record having a highest occurrence frequency among the travel records extracted by the extractor; and
a controller configured to activate the power generator on the basis of the future consumption estimated by the future consumption estimator.

2. The vehicle control system according to claim 1, wherein the future consumption estimator is configured to estimate the future consumption of the vehicle on the basis of an energy consumption that is associated with the pattern of the travel record having the highest occurrence frequency if occurrence frequencies of travel records are equal to or higher than a threshold value and to estimate the future consumption of the vehicle on the basis of an energy consumption that is associated with the travel record having the highest energy consumption of the vehicle if the occurrence frequencies are less than the threshold value.

3. The vehicle control system according to claim 1, wherein the future consumption estimator is configured to estimate the future consumption of the vehicle on the basis of information indicating the current position information and travel environment of the vehicle at time intervals of a predetermined duration or each time the vehicle travels a predetermined distance.

4. The vehicle control system according to claim 1, wherein the storage unit is configured to store charging point information regarding points where charging of the vehicle is possible, and
the future consumption estimator is configured to estimate the future consumption of the vehicle on the basis of an energy consumption of a travel record acquired by giving higher priority to a travel record having no point where charging of the vehicle is possible than a travel record having a point where charging of the vehicle is possible among the travel records extracted by the extractor on the basis of the charging point information stored in the storage unit.

5. A vehicle control method for a computer mounted in a vehicle including a power generator having an internal combustion engine configured to output motive power for use by an electric motor and the electric motor configured to generate power using the motive power output by the internal combustion engine, a storage battery configured to store power generated by the power generator, and a travel electric motor connected to driving wheels of the vehicle and configured to be driven using power supplied from the storage battery to rotate the driving wheels, the vehicle control method comprising:
the computer storing a travel history in which an energy consumption of the vehicle and information indicating a travel environment of the vehicle are associated with a route from a departure point to a destination of the vehicle in a storage unit;
checking information indicating a current position information and travel environment of the vehicle with the travel history stored in the storage unit to extract travel records having a degree of matching equal to or greater than a predetermined value;
estimating a future consumption of the vehicle on the basis of an energy consumption that is associated with a pattern of a travel record having a highest energy consumption of the vehicle or a travel record having a highest occurrence frequency among the extracted travel records; and
activating the power generator on the basis of the estimated future consumption.

6. A computer readable non-transitory storage medium that stores a program causing a computer mounted in a vehicle including a power generator having an internal combustion engine configured to output motive power for use by an electric motor and the electric motor configured to generate power using the motive power output by the internal combustion engine, a storage battery configured to store power generated by the power generator, and a travel electric motor connected to driving wheels of the vehicle and configured to be driven using power supplied from the storage battery to rotate the driving wheels to:
store a travel history in which an energy consumption of the vehicle and information indicating a travel environment of the vehicle are associated with a route from a departure point to a destination of the vehicle in a storage unit;
check information indicating a current position information and travel environment of the vehicle with the travel history stored in the storage unit to extract travel records having a degree of matching equal to or greater than a predetermined value;
estimate a future consumption of the vehicle on the basis of an energy consumption that is associated with a pattern of a travel record having a highest energy consumption of the vehicle or a travel record having a highest occurrence frequency among the extracted travel records; and
activate the power generator on the basis of the estimated future consumption.
